(19) United States
(12) Patent Application Publication
(10) Pub. No.: US 2017/0230604 A1
(43) Pub. Date: Aug. 10, 2017

(54) CONTENT PROVIDING DEVICES, LIQUID CRYSTAL DEVICES (LCDS), AND DISPLAY SYSTEMS

(71) Applicant: Shenzhen China Star Optoelectronics Technology Co. Ltd., Shenzhen, Guangdong (CN)

(72) Inventors: Yu-Yeh CHEN, Shenzhen, Guangdong (CN); Yin-HUNG CHEN, Shenzhen, Guangdong (CN); Yu WU, Shenzhen, Guangdong (CN)

(73) Assignee: Shenzhen China Star Optoelectronics Technology Co. Ltd., Shenzhen, Guangdong (CN)

(21) Appl. No.: 14/903,376

(22) PCT Filed: Dec. 25, 2015
(86) PCT No.: PCT/CN2015/098972

§ 371 Date: Jan. 7, 2016

(30) Foreign Application Priority Data
Dec. 2, 2015 (CN) 201510872537.1

(51) Int. Cl. H04N 5/63; G09G 3/36

(52) U.S. Cl. CPC H04N 5/63; G09G 3/3674; G09G 3/3685; G09G 2310/08; G09G 2370/12

(57) ABSTRACT

A content providing device, a LCD, and a display system are disclosed. The display system includes a liquid crystal device and a content providing device. The content providing device is an external device connecting to the liquid crystal device to provide video signals to the liquid crystal device and to provide a power to the liquid crystal device. With the configuration, the internal structure of the LCD may be simplified and the light and thin design may be realized.

### BACKGROUND OF THE INVENTION

1. Field of the Invention

The present disclosure relates to liquid crystal display technology, and more particularly to a content providing device, a LCD, and a display system.

2. Discussion of the Related Art

The LCD TVs are characterized by attributes such as thin, energy saving, image stabilization, no radiation, etc., and thus are popular.

Referring to FIG. 1, the conventional liquid crystal television 10 generally includes a liquid crystal display 11, T-CON (Timer Control Register) control circuit board 12, SOC (System On Chip) board 13, a power supply circuit board 140, and other components. The power supply circuit board 140 includes a power supply circuit 141 and transformer circuit 142. The power supply circuit 141 connects to an external power source, such as household power supply equaling to 220V, and then converts the voltage provided by the external power. The converted voltage is provided to the transformer circuit 142. The transforming circuit 142 provides the voltage necessary to the T-CON control circuit board 12 and the SOC board 13 in accordance with the voltage provided by the power supply circuit 141. The transforming circuit 142 also converts the voltage provided by the power supply circuit 141 into the driving voltage required to drive backlit. The SOC board 13 mainly receives video signals from digital cable TV set-top box, and then process the video signals to obtain the display signals needed for the liquid crystal display. The T-CON control circuit board 12 drives the liquid crystal display 11 to display in accordance with the display signals provided by the SOC board 13.

The SOC board 13 has a variety of interfaces. In addition to television set-top box receiving digital video signals, the SOC board 13 may conduct operations through its own systems and SOC toward the LCD TVs. In addition, the SOC board 13 may also receive the video signals from smart set-top boxes 14, such as Baidu box, Lynx box, millet boxes, such that the television set-top box can directly display the video content. Wherein the smart set-top box 14 is typically connected to an external power source, i.e., 220V.

Currently, the intelligent set-top box 14 has been provided with powerful functions. Not only massive video content are provided, but also has Internet access. That is, the intelligent set-top box 14 may be installed with a variety of APPs. The intelligent set-top box 14 not only own the functions the same with traditional ones, but also can display TV channels, which are implemented by transmitting the content to the SOC board 13.

As shown in FIG. 1, the conventional LCD TVs 10 generally are configured with the power supply circuit to convert the voltage from the external power source, which results in a complex internal structure, and is not conducive to thin and light design.

### SUMMARY

The object of the invention is to provide a content providing device, a LCD, and a display system that can simply the internal structure of the LCD so as to contribute to the thin and light design of LCDs.

In one aspect, a liquid crystal display system includes: a liquid crystal device and a content providing device, the content providing device is an external device connecting to the liquid crystal device to provide video signals to the liquid crystal device and to provide a power to the liquid crystal device; the liquid crystal device does not include a power supply circuit; the liquid crystal device includes a liquid crystal display panel, a T-CON control circuit board, a gate COF, and a data COF, the T-CON control circuit board includes a conversion circuit, a T-CON control circuit and a first interface connecting to the content providing device; the conversion circuit converts video signals received from the first interface into display signals needed by the liquid crystal display panel to be displayed, and transmits the display signals to the T-CON control circuit board, the T-CON control circuit board controls the gate COF and the data COF in accordance with the display signals such that the liquid crystal display panel is driven to display images, the content providing device provides the power to the T-CON control circuit board via the first interface; and wherein the liquid crystal device does not include a SOC board.

Wherein the T-CON control circuit board further includes a signal transmission circuit, the T-CON control circuit generates control signals in accordance with the signals to be displayed, and transmits the control signals to a gate driving circuit or a data driving circuit on the liquid crystal display panel via the signal transmission circuit such that the gate driving circuit or the data driving circuit are controlled to drive the liquid crystal display panel.

Wherein the content providing device is a smart set-top box, and the first interface connects to a HDMI of the content providing device.

Wherein the system further includes a transformer circuit board and an adapter, the adapter includes an adapter circuit and a second interface and a third interface respectively connects to the adapter circuit, the first interface connects with the second interface, the third interface connects with the content providing device, such that the T-CON control circuit board connects with the content providing device via the adapter, the transformer circuit board connects with the second interface of the adapter, the content providing device provides the power to the transformer circuit and the T-CON control circuit board via the third interface of the adapter, the adapter circuit and the second interface in turn, the transformer circuit board is configured for converting a voltage provided by the content providing device into a driving voltage of a backlight driving circuit of the liquid crystal display panel; and the third interface includes first operation voltage input pins, second operation voltage input pins, and enable signals pins, the content providing device provides the power to the T-CON control circuit board via the first operation voltage input pins, provides the power to the transformer circuit board via the second operation voltage input pins, and provides enable signals to the transformer circuit board via the enable signals pins, such that the transformer circuit board provides the driving voltage to the backlight driving circuit of the liquid crystal display panel.

In another aspect, a content providing device, wherein the content providing device is an external device connecting to a liquid crystal device to provide video signals to the liquid crystal device and to provide a power to the liquid crystal device; and

wherein the liquid crystal device does not include a power supply circuit.

In another aspect, a liquid crystal device (LCD), wherein the LCD connects to an externally configured content providing device, and the LCD displays images in accordance with video signals provided by the content providing device, and the LCD obtains an operation voltage from the content providing device, and wherein the LCD does not include a power supply circuit.

Wherein the liquid crystal device includes a liquid crystal display panel, a T-CON control circuit board, and a signal conversion circuit board; the signal conversion circuit board includes a conversion circuit, and a first interface and a second interface respectively connecting to the conversion circuit, the first interface connects to the T-CON control circuit board, and the second interface connects with the content providing device, the conversion circuit converts the video signals received from the second interface into the display signals of the liquid crystal display panel and transmits the display signals to the T-CON control circuit board via the first interface, the T-CON control circuit board drives the liquid crystal display panel to display the images in accordance with the display signals; the content providing device provides the power to the T-CON control circuit board via the second interface and the first interface in turn; and wherein the liquid crystal device does not include a SOC board.

Wherein the LCD includes s liquid crystal display panel and a T-CON control circuit board, the T-CON control circuit board includes a conversion circuit, a T-CON control circuit and a first interface connecting the content providing device; the conversion circuit converts the video signals received from the first interface into display signals needed by the liquid crystal display panel to be displayed, and transmits the display signals to the T-CON control circuit board, the T-CON control circuit board controls the liquid crystal display panel to display images in accordance with the display signals, and the content providing device provides the power to the T-CON control circuit board via the first interface; and wherein the liquid crystal device does not include a SOC board.

Wherein the T-CON control circuit board further includes a signal transmission circuit, the T-CON control circuit generates control signals in accordance with the signals to be displayed, and transmits the control signals to a gate driving circuit or a data driving circuit on the liquid crystal display panel via the signal transmission circuit such that the gate driving circuit or the data driving circuit are controlled to drive the liquid crystal display panel.

Wherein the content providing device is a smart set-top box, and the first interface connects to a HDMI of the content providing device.

Wherein the system further includes a transformer circuit board and an adapter, the adapter includes an adapter circuit and a second interface and a third interface respectively connects to the adapter circuit, the first interface connects with the second interface, the third interface connects with the content providing device, such that the T-CON control circuit board connects with the content providing device via the adapter, the transformer circuit board connects with the second interface of the adapter, the content providing device provides the power to the transformer circuit and the T-CON control circuit board via the third interface of the adapter, the adapter circuit and the second interface in turn, the transformer circuit board is configured for converting a voltage provided by the content providing device into a driving voltage of a backlight driving circuit of the liquid crystal display panel; and the third interface includes first operation voltage input pins, second operation voltage input pins, and enable signals pins, the content providing device provides the power to the T-CON control circuit board via the first operation voltage input pins, provides the power to the transformer circuit board via the second operation voltage input pins, and provides enable signals to the transformer circuit board via the enable signals pins, such that the transformer circuit board provides the driving voltage to the backlight driving circuit of the liquid crystal display panel.

In view of the above, the externally configured content providing device provides the power to the LCD. Thus, the LCD may obtain the operation voltage without the power supply circuit. With the configuration, the internal structure of the LCD may be simplified and the light and thin design may be realized.

### BRIEF DESCRIPTION OF THE DRAWINGS

FIG. 1 is a schematic view of one conventional LCD TV.

FIG. 2 is a schematic view of the liquid crystal display system in accordance with one embodiment.

FIG. 3 is a schematic view of the liquid crystal display system in accordance with another embodiment.

FIG. 4 is a schematic view of the liquid crystal display system in accordance with another embodiment.

FIG. 5 is a schematic view of the liquid crystal display system in accordance with another embodiment.

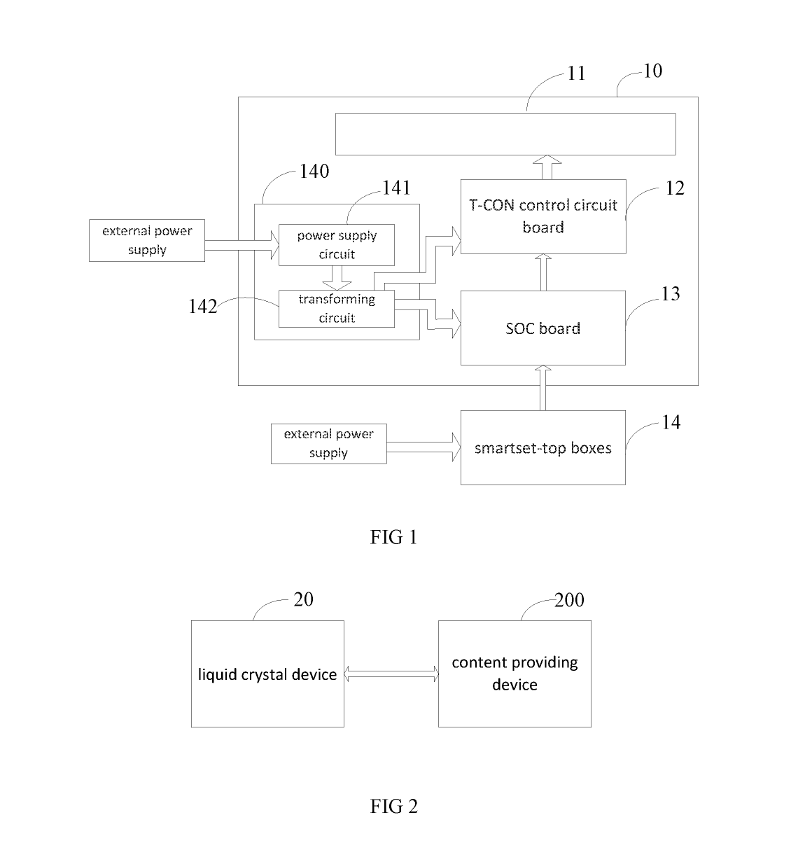

### DETAILED DESCRIPTION OF THE EMBODIMENTS

Embodiments of the invention will now be described more fully hereinafter with reference to the accompanying drawings, in which embodiments of the invention are shown.

FIG. 2 is a schematic view of the liquid crystal display system in accordance with one embodiment. The liquid crystal display system includes a liquid crystal device 20 and a content providing device 200. The liquid crystal device 20 may be the LCD TV.

The content providing device 200 is an external device connecting to the liquid crystal device 20 to provide the video signals to the liquid crystal device 20 and to provide a power to the liquid crystal device 20. In addition, there is no power supply circuit for converting the voltage of an external power supply within the liquid crystal device 20.

In one embodiment, the liquid crystal device 20 may obtain the voltage needed for operations via the external content providing device 200, and thus the liquid crystal device 20 may operate normally without being provided with the power supply circuit. In this way, the internal structure of the liquid crystal device 20 may be simplified, and the liquid crystal device 20 may be implemented in accordance with thin and light design. At the same time, the cost of the liquid crystal device 20 may be reduced.

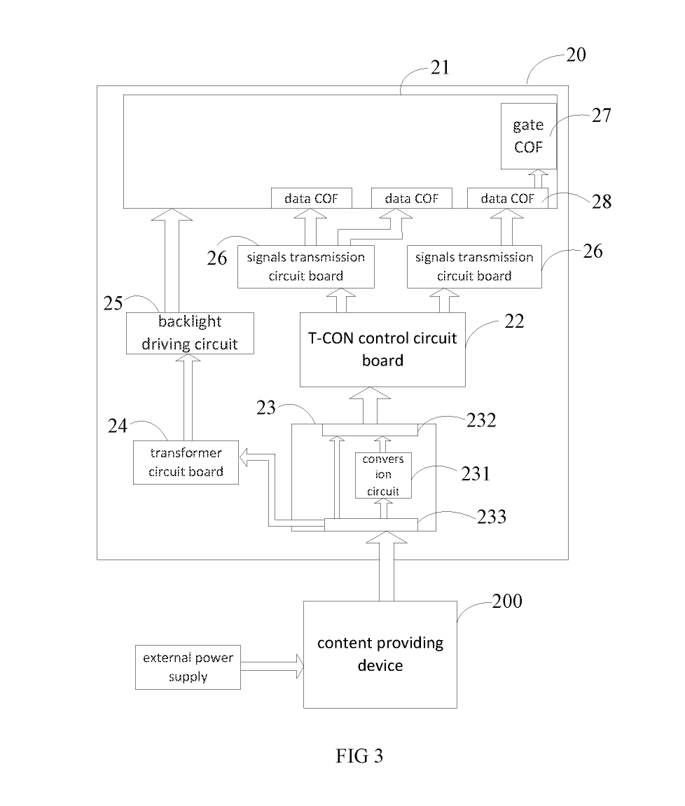

FIG. 3 is a schematic view of the liquid crystal display system in accordance with another embodiment. The components having the same reference numerals have the same functions. As shown in FIG. 3, the liquid crystal device 20 does not have the SOC board. The liquid crystal device 20 includes a liquid crystal display panel 21, a T-CON control circuit board 22, and a signal conversion circuit board 23.

The signal conversion circuit board 23 includes a conversion circuit 231, and a first interface 232 and a second interface 233 respectively connecting to the conversion circuit 231. The first interface 232 connects to the T-CON control circuit board 22, and the second interface 233 connects with the content providing device 200 that have been configured externally. The signal conversion circuit board 23 provides the display content for the liquid crystal device 20. The second interface 233 is configured for receiving the video signals from the signal conversion circuit board 23, the conversion circuit 231 converts the received video signals into the display signals of the liquid crystal display panel 21 to be displayed. The conversion circuit 231 also transmits the display signals to the T-CON control circuit board 22 via the first interface 232. In this way, the T-CON control circuit board 22 drives the liquid crystal display panel 21 to display the images in accordance with the display signals so as to realize the driving display of the liquid crystal display panel 21.

Wherein the content providing device 200 connects to the external power supply, such as household power supply equaling to 220V, so as to obtain the power from the external power supply. The content providing device 200 is configured with the power supply circuit internally for processing the voltage inputted from the external power supply so as to obtain the operation voltage for itself and also for the liquid crystal device 20. Further, the content providing device 200 provides the power to the T-CON control circuit board 22 via the second interface 233 and the first interface 232 in turn.

In the embodiment, the liquid crystal device 20 does not need the power supply circuit module, and only one signal conversion circuit board 23 has to configured within the liquid crystal device 20 for converting the video content from the content providing device 200 into display signals needed for the liquid crystal display panel 21. Thus, video content may be displayed without the additional and external SOC board. As such, the liquid crystal device 20 may decrease the number of components of the SOC board so as to reduce the cost. In addition, the conversion circuit 231 is configured for converting the signals, the complexity of the conversion circuit 231 is much less than that of the SOC board. In this way, the internal structure of the liquid crystal device 20 may be simplified, and the liquid crystal device 20 may be implemented in accordance with thin and light design.

The content providing device 200 may be a smart set-top box, such as Baidu box, Lynx box, millet box, or other content providing devices. The second interface 233 of the signal conversion circuit board 23 is configured for connecting the High Definition Multimedia Interface (HDMI) of the content providing device 200. That is, the video content provided by the content providing device 200 is the video data of high definition.

Referring to FIG. 3, the liquid crystal device 20 further includes a transformer circuit board 24, a backlight driving circuit 25, a multiple signals transmission circuit board 26, a gate COF 27, and a data COF 28.

The backlight driving circuit 25 is the circuit within the backlight module. The backlight driving circuit 25 is configured for driving the backlight of the liquid crystal display panel 21. The transformer circuit board 24 connects with the second interface 233 of the signal conversion circuit board 23 and with the multiple signals transmission circuit board 26. The content providing device 200 provides the power for the transformer circuit board 24 via the second interface 233. The transformer circuit board 24 is configured for converting the voltage provided by the content providing device 200 into the driving voltage needed for the backlight driving circuit 25, and for outputting the driving voltage to the backlight driving circuit 25. As such, the backlight of the liquid crystal display panel 21 is driven to emit lights by the backlight driving circuit 25, and the liquid crystal display panel 21 is capable of displaying the images.

The second interface 233 includes first operation voltage input pins, second operation voltage input pins, and enable signals pins. The content providing device 200 inputs the operation voltage to the T-CON control circuit board 22 via the first operation voltage input pins, and inputs the operation voltage to the transformer circuit board 24 via the second operation voltage input pins, wherein the first operation voltage input pins is 12V, and the second operation voltage input pins is 24V. That is, the content providing device 200 provides the voltage equaling to 12V to the T-CON control circuit board 22, and provides the voltage equaling to 24V to the transformer circuit board 24. It can be understood that different voltages may be provided to the T-CON control circuit board and the transformer circuit board in accordance with the type of the LCDs.

In addition, the transformer circuit board 24 receives the enable signals from the content providing device 200 via the enable signals pins via the second interface 233. When the content providing device 200 is turned on or when the standby state transits to the operation state, the enable signals are transmitted to the liquid crystal device 20 such that the liquid crystal device 20 begins its operation. The transformer circuit board 24 receives the enable signals such that the enable signals provides the driving voltage to the backlight driving circuit 25. In this way, the backlight driving circuit drives the backlight to emit lights.

A non-display area in a rim of the liquid crystal display panel 21 is bonded with a gate driving IC connecting to the scanning lines of the liquid crystal display panel 21 and is bonded with a data driving IC connecting to the data lines of the liquid crystal display panel 21. The gate driving IC and the data driving IC are encapsulated by chip on film (COF) technology, in which soft circuit boards are adopted as the encapsulation carrier, and the IC is fixed on the soft circuit board. The gate COF 27 relates to the soft circuit board for encapsulating the gate driving IC, and the data COF 28 relates to the soft circuit board for encapsulating the data driving IC. As the number of the ICs is large, the numbers of the gate COF 27 and the data COF 28 are large. Each of the gate COFs 27 is encapsulated with a plurality of gate driving ICs, and each of the data COF 28 is encapsulated with a plurality of data driving ICs. The gate COFs 27 are arranged at a short side of the liquid crystal display panel 21 in turn, and the data COFs 28 are arranged at a long side of the liquid crystal display panel 21 in turn.

The T-CON control circuit board 22 is configured for generating the control signals respectively needed by the gate driving IC and the data driving IC in accordance with the display signals. The multiple signals transmission circuit board 26 includes a plurality of transmission wirings for transmitting the control signals generated by the T-CON control circuit board 22 to the corresponding data driving IC on the gate COF 46 and the data driving IC on the data COF 28. Further, in the embodiment, the data COFs 28 connect directly with the multiple signals transmission circuit board 26, wherein one of the multiple signals transmission circuit boards 26 connects to the data driving IC on one of the data COFs 28 or connects to the data driving ICs on a plurality of data COFs 28. The gate COFs 27 are not directly connected to the multiple signals transmission circuit board 26. The gate COFs 27 receive the control signals of the T-CON control circuit board 22 via the data COF 28 and the multiple signals transmission circuit board 26 in turn. Specifically, with respect to the data COFs 28 arranged in sequence, a portion of the transmission wirings on the multiple signals transmission circuit boards 26, which connects two ends of the data COF 28, connects the data driving IC on the data COF 28 so as to transmit the data signals from the T-CON control circuit board 22 to the data driving IC. Another portion of the transmission wirings passes through a blank area of the data COF 28 and connects with the gate driving IC on the gate COF 27 so as to transmit the control signals from the T-CON control circuit board 22 to the gate driving IC. In this way, the data driving IC and gate driving IC drive the liquid crystal display panel 21 to display the image in accordance with the received control signals, respectively. That is, the control signals needed by the gate driving IC are transmitted to the gate driving IC via the multiple signals transmission circuit board 26 and the data COF 28 nearest to the gate COF 27. The control signals needed by the data driving IC are transmitted directly by the multiple signals transmission circuit board 26.

FIG. 3 only shows two multiple signals transmission circuit boards 26. In real applications, more multiple signals transmission circuit boards 26 may be configured in accordance with the dimension of the liquid crystal display panel 21 so as to connect with the data COF 28 and the T-CON control circuit board 22.

The process of how the liquid crystal display panel 21 displays the images will be described hereinafter. After the content providing device 200 is turned on, the content providing device 200 provides the power to the liquid crystal device 20. Specifically, the content providing device 200 respectively provides the power to the T-CON control circuit board 22 and the transformer circuit board 24. The video signals of the content providing device 200 are transmitted to the conversion circuit 231 via the second interface 233. The conversion circuit 231 converts the video signals of the content providing device 200, such as format conversion, so as to obtain the display signals that can be recognized by the liquid crystal display panel 21. In addition, the conversion circuit 231 transmits the display signals to the T-CON control circuit board 22 via the first interface 232. The T-CON control circuit board 22 respectively generates the control signals needed by the gate driving IC and the data driving IC in accordance with the display signals, and transmits the corresponding control signals to the gate driving IC and the data driving IC via the multiple signals transmission circuit board 26. In this way, the gate driving IC outputs the scanning signals to the liquid crystal display panel 21, and the data driving IC outputs the data signals to the liquid crystal display panel 21. Thus, the liquid crystal display panel 21 is driven to display the images. Specifically, the T-CON control circuit board 22 generates the control signals needed by the gate driving IC, and the control signals are transmitted to the gate driving IC on the gate COF 27 via the multiple signals transmission circuit board 26 and the data COF 28 in turn.

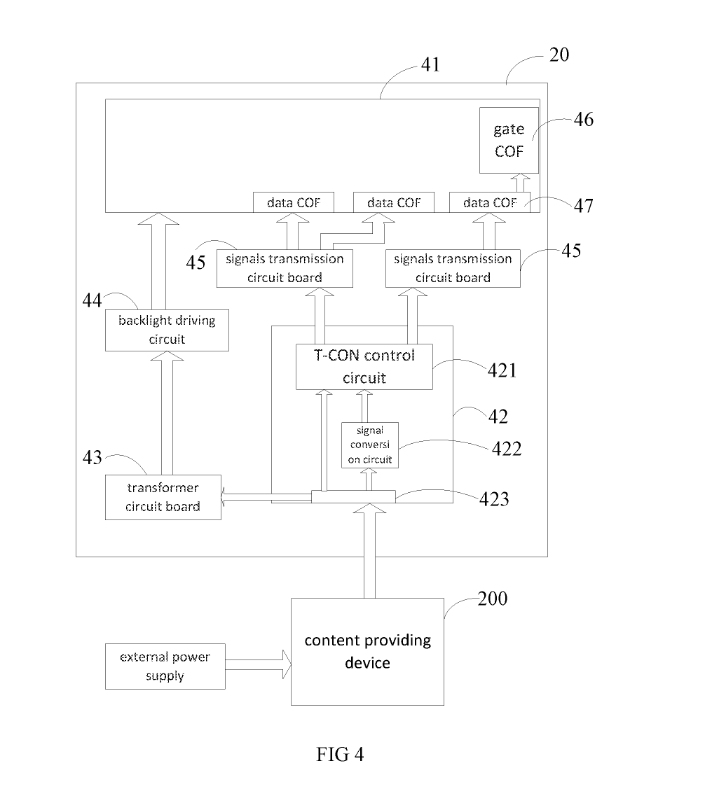

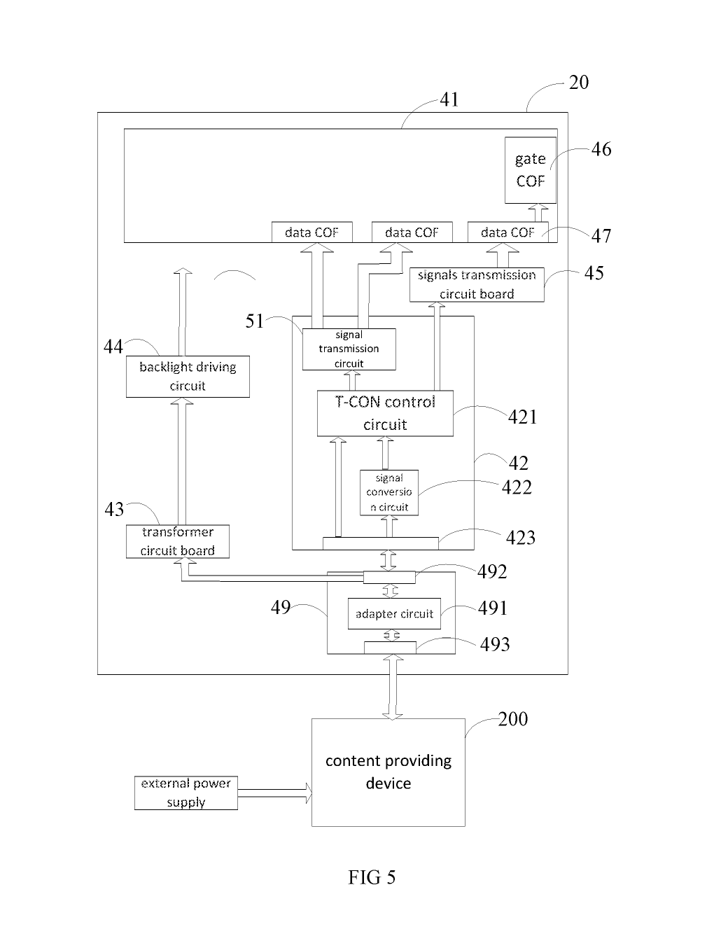

FIG. 4 is a schematic view of the liquid crystal display system in accordance with another embodiment. In the embodiment, the liquid crystal device 20 includes a liquid crystal display panel 41 and a T-CON control circuit board 42. The liquid crystal device 20 does not include the SOC board.

The T-CON control circuit board 42 connects with the liquid crystal display panel 41, and connects to an external content providing device 200 so as to convert the video signals from the content providing device 200 to the display signals needed by the liquid crystal display panel 41. In addition, the T-CON control circuit board 42 drives the liquid crystal display panel 41 to display the images in accordance with the display signals. In this way, the liquid crystal display panel 41 is driven to display the images.

Further, the T-CON control circuit board 42 includes a T-CON control circuit 421, a signal conversion circuit 422, and a first interface 423. The T-CON control circuit 421 connects with the liquid crystal display panel 41 and the signal conversion circuit 422. The first interface 423 is configured for connecting the HDMI of the content providing device 200. That is, the video content provided by the content providing device 200 is the video data of high definition. The content providing device 200 provides the power to the T-CON control circuit 421 via the first interface 423.

The signal conversion circuit 422 converts the video signals from the content providing device 200 via the first interface 423 to the display signals needed by the liquid crystal display panel 41, and transmits the display signals to the T-CON control circuit 421. The T-CON control circuit 421 drives the liquid crystal display panel 41 to display the images in accordance with the display signals.

Referring to FIG. 4, the liquid crystal device 20 further includes a transformer circuit board 43, a backlight driving circuit 44, a signals transmission circuit board 45, a gate COF 46, and a data COF 47.

The backlight driving circuit 44 is the circuit within the backlight module. The backlight driving circuit 44 is configured for driving the backlight of the liquid crystal display panel 41. The transformer circuit board 43 connects with the first interface 423 and the backlight driving circuit 44. The content providing device 200 provides the power for the transformer circuit board 43 via the first interface 423.

The transformer circuit board 43 is configured for converting the voltage provided by the content providing device 200 into the driving voltage needed for the backlight driving circuit 44, and for outputting the driving voltage to the backlight driving circuit 44. As such, the backlight of the liquid crystal display panel 21 is driven to emit lights by the backlight driving circuit 44, and the liquid crystal display panel 41 is capable of displaying the images.

The first interface 423 includes first operation voltage input pins, second operation voltage input pins, and enable signals pins. The content providing device 200 inputs the operation voltage to the T-CON control circuit board 421 via the first operation voltage input pins, and inputs the operation voltage to the transformer circuit board 43 via the second operation voltage input pins, wherein the first operation voltage input pins is 12V, and the second operation voltage input pins is 24V. That is, the content providing device 200 provides the voltage equaling to 12V to the T-CON control circuit board 421, and provides the voltage equaling to 24V to the transformer circuit board 43. It can be understood that different voltages may be provided to the T-CON control circuit board and the transformer circuit board in accordance with the type of the LCDs.

In addition, the transformer circuit board 43 receives the enable signals from the content providing device 200 via the enable signals pins via the first interface 423. When the content providing device 200 is turned on or when the standby state transits to the operation state, the enable signals are transmitted to the liquid crystal device 20 such that the liquid crystal device 20 begins its operation. The transformer circuit board 43 receives the enable signals such that the enable signals provides the driving voltage to the backlight driving circuit 44. In this way, the backlight driving circuit drives the backlight to emit lights.

The T-CON control circuit board 22 is configured for generating the control signals respectively needed by the gate driving IC and the data driving IC in accordance with the display signals. The signals transmission circuit board 45 is configured for transmitting the control signals generated by the T-CON control circuit board 421 to the corresponding data driving IC on the gate COF 46 and the data driving IC on the data COF 28. Further, in the embodiment, the data COFs 47 connect directly with the multiple signals transmission circuit board 45, wherein one of the multiple signals transmission circuit boards 45 connects to the data driving IC on one of the data COFs 47 or connects to the data driving ICs on a plurality of data COFs 47. The gate COFs 46 are not directly connected to the multiple signals transmission circuit board 45. The gate COFs 46 receive the control signals of the T-CON control circuit board 22 via the data COF 47 and the multiple signals transmission circuit board 45 in turn. Specifically, with respect to the data COFs 47 arranged in sequence, a portion of the transmission wirings on the multiple signals transmission circuit boards 45, which connects two ends of the data COF 47, connects the data driving IC on the data COF 47 so as to transmit the data signals from the T-CON control circuit board 421 to the data driving IC.

Another portion of the transmission wirings passes through a blank area of the data COF 47 and connects with the gate driving IC on the gate COF 46 so as to transmit the control signals from the T-CON control circuit board 421 to the gate driving IC. In this way, the data driving IC and gate driving IC drive the liquid crystal display panel 41 to display the image in accordance with the received control signals, respectively. That is, the control signals needed by the gate driving IC are transmitted to the gate driving IC via the multiple signals transmission circuit board 45 and the data COF 47 nearest to the gate COF 46. The control signals needed by the data driving IC are transmitted directly by the multiple signals transmission circuit board 45.

The process of how the liquid crystal display panel 41 displays the images will be described hereinafter. After the content providing device 200 is turned on, the content providing device 200 provides the power to the liquid crystal device 20. Specifically, the content providing device 200 respectively provides the power to the T-CON control circuit board 421 and the transformer circuit board 44. The video signals of the content providing device 200 are transmitted to the conversion circuit 422 via the first interface 423. The conversion circuit signal conversion circuit 422 converts the video signals of the content providing device 200, such as format conversion, so as to obtain the display signals that can be recognized by the liquid crystal display panel 41. In addition, the conversion circuit 422 transmits the display signals to the T-CON control circuit board 421. The T-CON control circuit board 421 respectively generates the control signals needed by the gate driving IC and the data driving IC in accordance with the display signals, and transmits the corresponding control signals to the gate driving IC and the data driving IC via the multiple signals transmission circuit board 45. In this way, the gate driving IC outputs the scanning signals to the liquid crystal display panel 41, and the data driving IC outputs the data signals to the liquid crystal display panel 41. Thus, the liquid crystal display panel 41 is driven to display the images.

In view of the above, the liquid crystal device 20 is not configured with the SOC board. The liquid crystal device 20 may display video content by connecting the external content providing device 200. This may enhance the internal structure of the liquid crystal device 20, and may reduce the cost. In addition, the T-CON control circuit board 42 is incorporated with the signals conversion functions. That is, the additional circuit board for converting the signals is not needed. In this way, the space occupied by the circuit board may be reduced so as to realize the light and thin design.

FIG. 5 is a schematic view of the liquid crystal display system in accordance with another embodiment. The components having the same reference numerals have the same functions. In the embodiment, one of the signals transmission circuit board 45 is integrated on the same circuit board. Specifically, the signal transmission circuit 51 of one of the signals transmission circuit board 45 is formed on the T-CON control circuit board 42. That is, the T-CON control circuit board 42 includes the signal transmission circuit 51, wherein the signal transmission circuit 51 is the transmission wirings. The T-CON control circuit 421 respectively generates the control signals needed by the gate driving IC and the data driving IC in accordance with the display signals, and transmits the corresponding control signals to the gate driving IC and the data driving IC via the signal transmission circuit 51 and the transmission wirings on the signals transmission circuit board 45. In this way, the data driving IC outputs the data signals to the liquid crystal display panel 41. In addition, the corresponding control signals are transmitted to the gate driving IC on the gate COF 46 via the signals transmission circuit board 45 and the data COF 47 such that the gate driving IC is controlled to output the scanning signals to the liquid crystal display panel 41 to accomplish the display.

Conventionally, the transmission circuit and the T-CON control circuit board are respectively formed on two circuit boards. In the embodiment, one of the signal transmission circuit board is integrated with the T-CON control circuit board, which may simplify the internal structure of the liquid crystal device 20. In this way, the space occupied by the circuit board may be reduced so as to realize the light and thin design.

In other embodiments, a plurality of signal transmission circuit board may be integrated with the T-CON control circuit board on the same circuit board.

Referring to FIG. 5, the liquid crystal device 20 further includes an adapter 49. The T-CON control circuit board 42 connects with the content providing device 200 via the adapter 49. The transformer circuit board 43 connects with the content providing device 200 via the adapter 49. That is, the adapter 49 connects between the first interface 423 and the content providing device 200 such that the signals between the content providing device 200 and the liquid crystal device 20 are transmitted via the adapter 49. Specifically, the adapter 49 includes an adapter circuit 491, a second interface 492 and a third interface 493 respectively connects with the adapter circuit 491. The second interface 492 connects with the first interface 423 of the T-CON control circuit board 42, the third interface 493 connects with the content providing device 200, and the transformer circuit board 43 connects with the second interface 492.

The content providing device 200 provides the video signals to the signal conversion circuit 422 and provides the power to the T-CON control circuit 421 via the third interface 493, the adapter circuit 491, the second interface 492, and the first interface 423 in turn. The content providing device 200 also provides the power to the transformer circuit board 43 via the third interface 493, the adapter circuit 491, and the second interface 492 in turn.

In the embodiment, the third interface 493 includes first operation voltage input pins, second operation voltage input pins, and enable signals pins.

The content providing device 200 inputs the operation voltage to the T-CON control circuit board 421 via the first operation voltage input pins, and inputs the power to the transformer circuit board 43 via the second operation voltage input pins, and inputs the enable signals to the transformer circuit board 43 via the enable signals pins.

The adapter circuit 491 is configured for converting the signals from the content providing device 200 via the third interface 493 into the signals that are compatible with the second interface 492. Further, the signals are transmitted to the T-CON control circuit board 42 and the transformer circuit board 43 via the second interface 492.

By adopting the adapter 49, when the content providing device 200 is different, it is not necessary to change the first interface 423 on the T-CON control circuit board 42 and the circuits on the T-CON control circuit board 42. The only thing is to adopt the adapter 49 that is compatible with the pins of the content providing device 200. In this way, the same T-CON control circuit board 42 may be suitable for different content providing device 200.

In addition, the T-CON control circuit board 42 is configured in a central location of the liquid crystal device 20. As the liquid crystal device 20 is usually arranged close to the wall or is hanged on the wall, it is not convenient to plug the device if the content providing device 200 directly connects to the T-CON control circuit board 42. In addition, the T-CON control circuit board 42 or other circuit boards connected with the T-CON control circuit board 42 may be damaged during the plug process. In the embodiment, the content providing device 200 is connected via the adapter 49, and the adapter 49 may be arranged at a lateral side of the liquid crystal device 20. Users only need to plug or remove the content providing device 200 via the interface of the adapter 49, which contributes to the user operations. In addition, the adapter 49 is directly accessed during the plug process. As such, the T-CON control circuit board 42 is prevented from being pulled and thus the internal circuits may be protected.

In one embodiment, a content providing device may be any one of the above content providing device.

In one embodiment, a LCD may be any one of the liquid crystal devices.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A liquid crystal display system, comprising:
a liquid crystal device and a content providing device, the content providing device is an external device connecting to the liquid crystal device to provide video signals to the liquid crystal device and to provide a power to the liquid crystal device;
the liquid crystal device does not comprise a power supply circuit;
the liquid crystal device comprises a liquid crystal display panel, a T-CON control circuit board, a gate COF, and a data COF, the T-CON control circuit board comprises a conversion circuit, a T-CON control circuit and a first interface connecting to the content providing device;
the conversion circuit converts video signals received from the first interface into display signals needed by the liquid crystal display panel to be displayed, and transmits the display signals to the T-CON control circuit board, the T-CON control circuit board controls the gate COF and the data COF in accordance with the display signals such that the liquid crystal display panel is driven to display images, the content providing device provides the power to the T-CON control circuit board via the first interface; and
wherein the liquid crystal device does not include a SOC board.

2. The liquid crystal display system as claimed in claim 1, wherein the T-CON control circuit board further comprises a signal transmission circuit, the T-CON control circuit generates control signals in accordance with the signals to be displayed, and transmits the control signals to a gate driving circuit or a data driving circuit on the liquid crystal display panel via the signal transmission circuit such that the gate driving circuit or the data driving circuit are controlled to drive the liquid crystal display panel.

3. The liquid crystal display system as claimed in claim 1, wherein the content providing device is a smart set-top box, and the first interface connects to a HDMI of the content providing device.

4. The liquid crystal display system as claimed in claim 3, wherein the system further comprises a transformer circuit board and an adapter, the adapter comprises an adapter circuit and a second interface and a third interface respectively connects to the adapter circuit, the first interface connects with the second interface, the third interface connects with the content providing device, such that the T-CON control circuit board connects with the content providing device via the adapter, the transformer circuit board connects with the second interface of the adapter, the content providing device provides the power to the transformer circuit and the T-CON control circuit board via the third interface of the adapter, the adapter circuit and the second interface in turn, the transformer circuit board is configured for converting a voltage provided by the content providing device into a driving voltage of a backlight driving circuit of the liquid crystal display panel; and
the third interface comprises first operation voltage input pins, second operation voltage input pins, and enable signals pins, the content providing device provides the power to the T-CON control circuit board via the first operation voltage input pins, provides the power to the transformer circuit board via the second operation voltage input pins, and provides enable signals to the transformer circuit board via the enable signals pins, such that the transformer circuit board provides the driving voltage to the backlight driving circuit of the liquid crystal display panel.

5. A content providing device, wherein the content providing device is an external device connecting to a liquid crystal device to provide video signals to the liquid crystal device and to provide a power to the liquid crystal device; and
wherein the liquid crystal device does not comprise a power supply circuit.

6. A liquid crystal device (LCD), wherein the LCD connects to an externally configured content providing device, and the LCD displays images in accordance with video signals provided by the content providing device, and the LCD obtains an operation voltage from the content providing device, and wherein the LCD does not comprise a power supply circuit.

7. The LCD as claimed in claim 6, wherein the liquid crystal device comprises a liquid crystal display panel, a T-CON control circuit board, and a signal conversion circuit board;
the signal conversion circuit board comprises a conversion circuit, and a first interface and a second interface respectively connecting to the conversion circuit, the first interface connects to the T-CON control circuit board, and the second interface connects with the content providing device, the conversion circuit converts the video signals received from the second interface into the display signals of the liquid crystal display panel and transmits the display signals to the T-CON control circuit board via the first interface, the T-CON control circuit board drives the liquid crystal display panel to display the images in accordance with the display signals;
the content providing device provides the power to the T-CON control circuit board via the second interface and the first interface in turn; and
wherein the liquid crystal device does not include a SOC board.

8. The LCD as claimed in claim 6, wherein the LCD comprises s liquid crystal display panel and a T-CON control circuit board, the T-CON control circuit board comprises a conversion circuit, a T-CON control circuit and a first interface connecting the content providing device;
the conversion circuit converts the video signals received from the first interface into display signals needed by the liquid crystal display panel to be displayed, and transmits the display signals to the T-CON control circuit board, the T-CON control circuit board controls the liquid crystal display panel to display images in accordance with the display signals, and the content providing device provides the power to the T-CON control circuit board via the first interface; and
wherein the liquid crystal device does not include a SOC board.

9. The LCD as claimed in claim 8, wherein the T-CON control circuit board further comprises a signal transmission circuit, the T-CON control circuit generates control signals in accordance with the signals to be displayed, and transmits the control signals to a gate driving circuit or a data driving circuit on the liquid crystal display panel via the signal transmission circuit such that the gate driving circuit or the data driving circuit are controlled to drive the liquid crystal display panel.

10. The LCD as claimed in claim 8, wherein the content providing device is a smart set-top box, and the first interface connects to a HDMI of the content providing device.

11. The LCD as claimed in claim 10, wherein the system further comprises a transformer circuit board and an adapter, the adapter comprises an adapter circuit and a second interface and a third interface respectively connects to the adapter circuit, the first interface connects with the second interface, the third interface connects with the content providing device, such that the T-CON control circuit board connects with the content providing device via the adapter, the transformer circuit board connects with the second interface of the adapter, the content providing device provides the power to the transformer circuit and the T-CON control circuit board via the third interface of the adapter, the adapter circuit and the second interface in turn, the transformer circuit board is configured for converting a voltage provided by the content providing device into a driving voltage of a backlight driving circuit of the liquid crystal display panel; and
the third interface comprises first operation voltage input pins, second operation voltage input pins, and enable signals pins, the content providing device provides the power to the T-CON control circuit board via the first operation voltage input pins, provides the power to the transformer circuit board via the second operation voltage input pins, and provides enable signals to the transformer circuit board via the enable signals pins, such that the transformer circuit board provides the driving voltage to the backlight driving circuit of the liquid crystal display panel.
